(19) United States
(12) Patent Application Publication
(10) Pub. No.: US 2005/0008576 A1
(43) Pub. Date: Jan. 13, 2005

(54) Carrier foam to enhance liquid functional performance

(76) Inventor: Munzer Makansi, Signal Mountain, TN (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/867,069

(22) Filed: Jun. 14, 2004

Related U.S. Application Data
(63) Continuation-in-part of application No. 10/402,169, filed on Mar. 28, 2003, now Pat. No. 6,756,352.
(60) Provisional application No. 60/369,366, filed on Apr. 1, 2002.
(60) Provisional application No. 60/509,931, filed on Oct. 9, 2003.
(60) Provisional application No. 60/527,204, filed on Dec. 5, 2003.

(51) Int. Cl. A01N 25/04; B05B 1/28; C11D 17/00

(52) U.S. Cl. 424/43; 239/337; 239/120; 510/370

(57) ABSTRACT

A carrier fluid foam, which enhances the functional performance of liquids containing one or more functional active agents such as cleaners, lubricants, agricultural chemicals, household chemicals, industrial chemicals, institutional chemicals, medicinal chemicals, cosmetic chemicals and pharmaceutical chemicals, contains a solution of the functional active agent and a surfactant and has a particular combination of foam syneresis value, foam horizontal thickness half-life, and vertical wall clingability, and compared to liquids containing the same active agents, provides superior performance, normally without scrubbing. The carrier fluid foam is produced by vigorous agitation of the solution containing the active agent and a surfactant in the presence of a gas, or by injection of a pressurized propellant into an aerosol dispenser containing such solution and then passing the solution/propellant mix through a mechanical break-up actuator in the valve assembly of the aerosol dispenser.

### CROSS REFERNCE TO RELATED APPLICATIONS

This application is a continuation-in-part of U.S. application Ser. No. 10/402,169 filed Mar. 28, 2003, which claims priority to and the benefit of provisional application Ser. No. 60/369,366 filed Apr. 1, 2002. This application also claims priority to and the benefit of U.S. provisional patent application Ser. No. 60/509,931 filed Oct. 9, 2003 and U.S. provisional patent application Ser. No. 60/527,204 filed Dec. 5, 2003.

### BACKGROUND OF THE INVENTION

1. Field of the Invention

This invention relates to a carrier fluid foam composition which enhances the functional performance of liquids containing special active agents to accomplish specific tasks, such as cleaning and/or disinfecting stained and soiled surfaces, the fluid foam composition comprising a solution of one or more of the active agents. More particularly, the invention concerns cleaning, lubricant, agricultural chemical, industrial chemical and medicinal compositions which are in the form of a fluid foam having a particular combination of characteristics and a process for preparing the composition fluid foam.

2. Description of the Prior Art

Various liquid cleaning products, lubricants, agricultural chemicals, industrial chemicals and medicinal products are available commercially for use in household, janitorial, agricultural and industrial uses. Also some liquid medicines are topically applied on the skin with cotton swabs. These products contain active agents such as detergents to remove soil and oily stains, oxidizing compounds such as hydrogen peroxide and sodium hypochlorite to bleach and remove mold and mildew stains and kill germs and viruses, reducing agents to remove ink and rust stains, mild bases like ammonia to remove soil and grease from window and other surfaces, strong bases such as sodium hydroxide to clean clogged sink drains or greasy ovens, organic and inorganic acids to remove calcium deposits, as well as other organic and inorganic compounds, used separately or in combination, for general and/or more specialized functions. Such products typically are contained in and dispensed from glass, metal or plastic bottles, some of which are equipped with hand-activated pumps for spraying the cleaner or medicine on a surface. The sprayed compositions usually are dispensed as liquids, short-lived foams, thickened liquids or gels. Examples of such commercial products include but are not limited to: Scrubbing Bubbles, distributed by S.C Johnson, Inc., Lime Away, distributed by Reckitt Benckeiser, Inc., Orange Clean, distributed by Orange Glo International, Inc., and Windex, distributed by S.C. Johnson, Inc., WD-40 oil spray lubricant distributed by WD-40 Company of San Diego, Calif., Hot Shot Roach and Ant killer distributed by Spectrum Group of United Industries, Inc. of Saint Louis, Mo., and Round Up Weed and Grass Killer, Ready-to-Use, distributed by Monsanto Company Lawn and Garden Products of Marysville, Ohio.

Several aqueous cleaning compositions for the removal of mildew stains, similar to those in the commercial products, are disclosed in patents, such as U.S. Pat. Nos. 5,281,280 (Lisowski et al), 5,290,470 (Dutcher et al), 5,567,247 (Hawes).

The present inventor found that although some of the known cleaning compositions perform satisfactorily as claimed on the label, some did not perform their cleaning functions at all, some were effective in removing only mild stains, some required repeated applications and some others required vigorous scrubbing

The use of thickening agents to increase viscosity and change flow characteristics of aqueous cleaning compositions in order to improve their cleaning ability is disclosed in various patents, as for example in U.S. Pat. Nos. 5,549,842 (Chang), 4,900,467 (Smith), 4,800,036 (Rose et al), and 4,337,163 (Schilp). The thickened liquids usually are disclosed for use as detergents in dishwashers, sink drains and laundry washers, and some are also suggested for removing mildew.

Although the known aqueous cleaning compositions are useful for removing some stains from surfaces, improvements are desired to their cleaning efficiency, so that multiple application cycles or scrubbing and/or high-pressure water-hosing, or longtime waiting, after the cleaning composition is applied on a stained surface, are normally not required.

### SUMMARY OF THE INVENTION

The present invention provides a carrier fluid foam composition with a combination of properties, which enhances the functional performance of liquids containing special active agents to accomplish specific tasks, such as cleaning and/or disinfecting stained and soiled surfaces, more efficiently, faster, easier and normally without scrubbing. The composition is of the type that comprises a solution of active agent including cleaning agent, disinfecting agent, lubricating agent, agricultural chemical agent, household pest control formulations, agricultural herbicide, pesticide and fungicide chemicals, industrial chemicals, institutional chemicals, medicinal chemicals, cosmetic chemicals or pharmaceutical chemicals and compatible surfactant or a mixture of surfactants and other optional additives as may be desired. In an exemplary embodiment, the composition is a fluid foam that has, in combination, as measured by methods described hereinafter, (a) a syneresis value in the range of 1 to 60%, preferably in the range of 2-40 %, (b) a foam horizontal thickness half-life of at least 8 minutes, preferably at least 12 minutes, and (c) a vertical-surface clingability of at least 4 minutes, preferably at least 7 minutes. Suitable compatible surfactants are cocamine oxide, sodium alkyl alkanoate and sodium dodecyl diphenyl disulfonate or mixtures thereof, present in a concentration range of 0.1 to 20%.

The invention also provides a method for forming the above-described composition fluid foam. In an exemplary embodiment, the method comprises (a) preparing a solution of the active agent and a compatible surfactant in a container and (b) vigorously agitating the solution in the presence of a gas with mechanical stirrers or by fluidic/pneumatic action of a fluid jet, preferably produced by a mechanical breakup actuator of an aerosol dispenser in the presence of propellant. Preferably, the foam is produced with a low-boiling hydrocarbon propellant in an aerosol dispenser made of materials compatible with the aqueous solution. Suitable propellants include propane, butane, isobutane and mixtures thereof and also Diethylether, 1,1,-Difluoromethane, 1,1,1,2-Tetrafuoroethane and mixtures thereof, in a concentration of 1 to 20%, preferably 3 to 10%, by weight of the aqueous cleaning composition. In a preferred aerosol dispenser, all parts and surfaces that contact the aqueous cleaning composition are of compatible metal, rubber, glass or plastic. Suitable plastic materials include polyethylene, polypropylene, nylon and polyester.

The invention also provides for a foam drip catcher device, which can be attached to the spray cap of an aerosol dispenser to collect the residual foam, which oozes out of the dispenser nozzle while in the off position after use.

The invention also provides for an extension tube, which can be attached to dispenser sprayer in order to spray hard-to-reach hidden places and also to prevent foam from dripping on the user's hand.

### BRIEF DESCRIPTION OF THE DRAWINGS

The invention will be more readily understood by reference to the accompanying drawings, in which:

FIG. 1 is a side elevational view of a graduated glass cylinder 10 in which the heights of foam 11 and separated liquid 12 are measured during a “syneresis value” test and wherein h₀ is the original height of the foam in the filled cylinder at the start of the test, and h₁ and h₂ are respectively the thickness of the separated liquid layer and the thickness of the foam layer at a given time during the test; and

FIG. 2 is a schematic representation of an aerosol dispenser suitable for dispensing an aqueous foam of the invention.

FIG. 3A is a front view, and FIG. 3B is a side view of schematic representations of a foam drip catcher designed to be attached to the front end of the horn of a spray cap.

FIG. 4A is a top view, FIG. 4B is a front view and FIG. 4C is a side view of schematic representations of a foam drip catcher chamber designed to be attached to a sprayer.

### DETAILED DESCRIPTION OF PREFERRED EMBODIMENTS

The following detailed description of exemplary embodiments of the present invention is included for purposes of illustration and is not intended to limit the scope of the invention. The scope is defined by the claims appended below.

Definitions

For convenience and clarity, the meaning will now be given of several terms and characteristics that are used to describe the invention. Descriptions of tests employed to quantitatively measure some of the characteristics follow the list of definitions.

“Mildew” refers to any one or combination of mycological stains including household mildew, algae, fungus, spores etc.

“Liquid” in the context of this invention refers to a single liquid, a liquid solution, an emulsion of two liquid phases, a suspension of a solid phase in a liquid phase or a dispersion of a liquid or a solid phase in a liquid phase.

“Stubborn mildew stain” refers to gray or black mildew which grew on a surface over a long period of time during which the mildew color typically changed from yellow to pink to green and finally to gray and black.

“Compatible” means that a particular material or substance being referred to does not substantially adversely affect cleaning efficiency of a fluid foam of the invention or the performance of its dispenser device.

“Clingability” refers to the ability of a foam to cling or adhere to a vertical surface, measured as described herein below.

“Osterizer” refers to an electric mixer, usually used in food preparation, but employed herein to prepare fluid foams of various compositions, as reported in the Examples.

“Pouched dispenser” or “barrier dispenser” refers to a pressurized dispenser in which the solution is contained inside a pouch made of materials compatible with the solution. The pouch itself being suspended from and sealed to the dispenser valve or mounting cup and not in intimate contact with the inner walls of the dispenser.

“Cleanability” refers to a numerical ranking of the degree of whiteness or color shade change that occurs as a result of the application of a cleaning composition to a stained panel, measured as described herein below.

“Precursor solution” refers to the cleaning composition of aqueous solution of active agent, surfactant and optional additives, prior to conversion of the cleaning composition into a fluid foam.

“Syneresis value” is a measure of the amount of liquid that separates from a fluid foam, measured as described herein below.

“Horizontal thickness half life” is the time interval required for a fluid foam to lose 50% of its thickness, as measured in the syneresis value test.

“Actuator with mechanical breakup” refers to a known actuator which incorporates a feature to reduce spray particle size (e.g., a circular or near circular swirl chamber, or a channel with several tangential entries).

“Soap scum” refers to accumulation of film deposits on bath tub, walls, glass doors or curtains in bathroom shower space, which form as a result of contact with splashed soap water from human skin during showering.

“NP-31 propellant” or “NA-31” propellant refers to an Aeron® propellant mixture of hydrocarbons consisting of 81.3% n-butane, 16.6% propane and 2.1% isobutane, and having a nominal vapor pressure of 225 KPa (33 psig). It is supplied by Diversified Propellant Company International, Inc, U.S.A.

“Sirena® Integrated Spray Cap” is a spray cap, which replaces the actuator button on an aerosol dispenser. It is supplied by Seaquist Perfect Dispensing of Gary, Ill., U.S.A.

ACC-U-SOL® Sprayer is another type of spray cap, which replaces the actuator button on an aerosol dispenser. It is supplied by Precision Valve, Inc. of Yonkers, N.Y., U.S.A.

Test Procedures

Mildew Cleanability. The cleaning effectiveness of different products, to remove mildew stain, is tested on a landscaping timber that has stubborn mildew stains distributed over its surface. The stained landscaping timber typically measures 240 cm. (8 feet) in length and about 7.2 cm. (3-in) by 10.2 cm. (4 inch) in rectangular cross-section with rounded edges. Landscaping timbers of this type frequently are found in yard or garden areas around residential homes. When exposed to the environment of a humid climate for a long time (e.g., a few years), the timbers become covered with a layer of a high intensity gray or black, stubborn mycological stains. Such stained timbers are ideal for running a large number of tests to evaluate and compare, side by side, the effectiveness of different mildew removers. In preparation for a series of cleanability tests, a landscaping timber is placed horizontally on the ground with the longer side of its cross section perpendicular to the ground. The timber is then marked with vertical lines to divide the timber into test panels of about 5-cm width. The panels are numbered for identification. Every other panel is used as a test panel on which a sample of the cleaning composition being tested is placed for a predetermined period of time. At the end of the time period, the test panel is rinsed with water. The non-treated stained alternate panels on each side of the test panel serve as controls.

At the completion of the tests and the rinsing with water, the test panels are allowed to dry without scrubbing. Then, the cleanliness of each test panel is measured relative to its adjacent controls by a method known as “Gray Scale for Evaluating Changes in Color”, referred to as ISO International Standard R105/1, Part 2. According to this method, the difference between the color of the test item and its adjacent controls is matched with the closest contrast between gray color pairs printed on a standard template. The scale on the gray scale template extends from 1 for the largest difference in color contrast to 5 for no visible contrast difference, with fractions in between making a total of 10 gray scale panel pairs. By use of standard tables published with the Gray Scale method, the numbers obtained from the gray scale comparison are converted to “Total Color Difference” expressed in “CIE Lab Units”. The total Color Differences range from zero CIE Lab Units for a gray scale rating of 5 to 13.7 CIE Lab Units (reported herein for simplicity as 14) for a gray scale rating of 1. In the examples below, all cleanability ratings are reported in CIE Lab Units.

Relative Viscosity. The relative viscosity of an aqueous precursor solution (i.e., the aqueous solution of active agent, surfactant and optional additives, prior to conversion into a carrier fluid foam) is measured herein by a simple laboratory apparatus having a vertical arrangement of a right conical plastic funnel with an outlet tube attached and sealed to a plastic capillary tube. The internal diameter of the circular upper end of the funnel is 5.1 cm. The diameter of the circular lower end of the funnel is 0.64 cm. The distance between the upper and lower ends of the conical portion of the funnel is of 4.5 cm. An exit stem extends 2.5 cm from the lower end of the funnel. A 17.8-cm long capillary tube of 0.1-cm internal diameter is inserted 2.0 cm into the end of the funnel stem and sealed thereto. The total capacity of the apparatus from the upper end of the funnel to the outlet end of the capillary tube is 35 cm³. All flows through the apparatus are measured at 21° C. To determine the relative viscosity of an aqueous liquid, (a) the apparatus is first completely filled with the liquid, (b) the time required for the liquid to flow through the apparatus is measured and (c) the time required for the same volume water to flow through the apparatus is measured. The relative viscosity, RV, of the aqueous liquid is defined as the ratio of tₜₑₛₜ to t_{water}, where tₜₑₛₜ is the measured time for the test liquid to flow through the apparatus and t_{water} is the measured time for water to flow through the apparatus. Relative viscosities at different shear rates are obtained by repeating the procedure with capillaries of different dimensions. The relative viscosities reported herein were measured on precursor solution at a shear rate of 7 sec⁻¹.

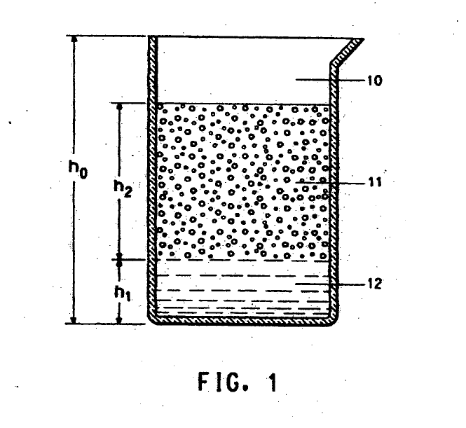

Syneresis Value and Foam Horizontal Thickness Half-life. The syneresis value and the horizontal thickness half-life of a fluid foam are measured with a graduated plastic or glass cylinder, as depicted in FIG. 1. The cylinder is initially filled completely to its full internal height h₀ with a cleaning composition foam and the cylinder is placed upright on a horizontal surface. The thickness h₂ of foam layer 11 and the thickness h₁ of separated liquid layer 12 are measured as functions of time during the test. The “syneresis value”, SV of the fluid foam, is expressed as a percentage of the initial thickness of the foam and is calculated by the formula, SV=100(h₁/h₀). Because the syneresis value rarely changes after 45 minutes of testing, the syneresis values reported herein were based on measurements made at about 45 minutes. A graph is prepared of the thickness h₂ of the foam, expressed as a % of the initial foam thickness h₀, versus time and the horizontal thickness half-life of a cleaning composition fluid foam is determined as the time (measured from the start of the test) at which 100(h₂/h₀) equals 50%.

Vertical Surface Clingability. The ability of a carrier fluid foam or other aqueous cleaning composition to cling to a vertical surface is measured as follows. A test fluid foam is sprayed onto or otherwise applied in sufficient quantity to substantially cover a vertical 7.2-cm. by 10.2 cm. test panel on one side of a landscaping timber (of the type described above in the “cleanability” test). With increasing time after cleaner application, the area covered by the foam shrinks. A graph is constructed of the % of the area covered by the shrinking test foam as a function of time after application. The vertical clingability reported herein is defined as the time required for the area of the applied test foam to shrink to 50% of its initial area coverage.

Carrier Fluid Foam

A typical foam composition in accordance with an exemplary embodiment of the present invention is a carrier fluid foam that contains (a) a solution of the primary active agent or a mixture of primary active agents, (b) a compatible surfactant, or a mixture of surfactants, in a concentration range of 0.1 to 20%, such as a cocamine oxide, (c) other optional enhancing agents, such as compatible fragrance, and (d) one or more optional additional compatible secondary active cleaning agents. The carrier fluid foam composition has a combination of characteristics that provides greatly improved efficiency to the primary active agent. The characteristics of the foam composition are (a) a foam syneresis value in the range of 1 to 60%, preferably 2 to 40%, (b) a foam horizontal thickness half life of at least 8 minutes, preferably at least 12 minutes, and (c) a foam vertical-surface clingability of at least 4 minutes, preferably at least 7 minutes. Because of this combination of characteristics, the present carrier fluid foam composition brings into contact with a surface substantially larger amounts of cleaning, stain-removing, lubricating, agricultural chemical, household chemical, industrial chemical, cosmetic or medicinal agents for longer reaction times than is provided by known compositions of equal active agent concentrations applied to a surface in the form of a sprayed liquid, a short-lived foam, a thickened liquid or a gel. The superior efficiency of the carrier fluid foams disclosed herein compared to known compositions is believed to be a result of the liquid-rich cells of the carrier fluid foam clinging strongly to the surface being treated and said cells breaking up slowly so that a continuous source of the active agent(s) is efficiently delivered to the surface. Thus, a carrier fluid foam of the present disclosure has a longer contact time with the applied surface and provides a greater amount of primary agent(s) to react with the intended object.

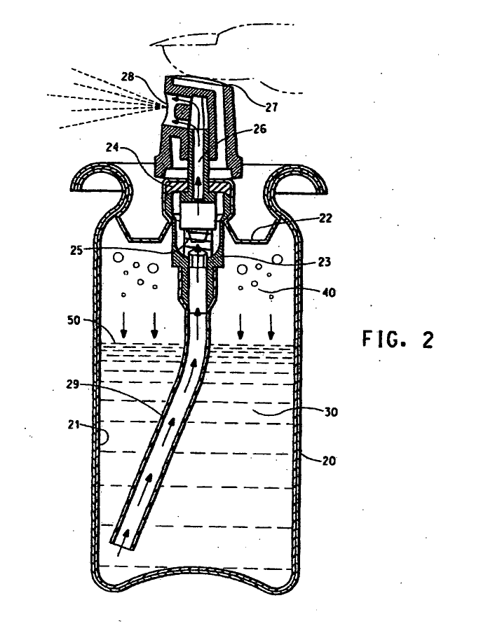

Additional enhancements provided by the carrier foam disclosed herein, particularly in connection with cleaning, mildew removal, and stain removal, include: (a) a cleansing detergent action which removes dirt, soil and oil stains from the treated surface while removing other stains or killing germs and viruses, (b) an ability of the foam to float and remain stable on water surface to clean the stains frequently formed at the edge of stagnant water in a container, such as mildew and rust stains in a toilet bowl, and (c) user friendliness. When the carrier foam is delivered by an aerosol dispenser, of the type shown in FIG. 2, the jet flow is delivered continuously with one pressing of the finger on the actuator button. The jet stream can be directed to a surface oriented at any angle, even when the dispenser is in used in the inverted position as in toilet bowl cleaning. Also the use of the present carrier foam avoids the need for hand pumping, the flow interruption and the jet starvation in inverted dispenser orientation, which are normally associated with the finger trigger pumped spray dispensers. The carrier foam properties of horizontal surface stability and floating characteristics can also be utilized effectively in cleaning oil spills from continental shores. In this case an appropriate active agent can be used with the proper surfactant, such as cocamine oxide, in a precursor solution. The solution can then be vigorously agitated and delivered to the stained water surface using either a large aerosol dispenser, scaled up to the size of a large pressurized gas cylinder, or by mechanical agitation in a continuous process device equipped with a stirrer similar to that of the Osterizer. Such devices can also be used to produce and spray the carrier foam of this invention to large areas in industrial or agricultural applications using industrial or agricultural chemicals with appropriate surfactants or mixtures of surfactants.

Suitable primary active cleaning agents include organic acids, inorganic acids, organic bases, ammonia, amines, salts of ammonia and amines, inorganic bases, carbonates, oxidizing and bleaching agents, terpenes, mixtures of a surfactant and a chelating agent, topically applied liquid medications, disinfectants, and commercially formulated liquid cleaners, lubricants, and chemicals used in household, agricultural, industrial, institutional, cosmetic and pharmaceutical applications.

Examples of suitable organic and inorganic acids include acetic acid, oxalic acid, citric acid, sulfuric acid, hydrochloric acid, nitric acid, phosphoric acid and sulfamic acid. Examples of suitable organic bases include ammonia, amines and salts thereof. An example of a suitable amine is monoethanolamine. Examples of suitable inorganic bases and carbonates include sodium hydroxide, potassium hydroxide, ammonium hydroxide, lithium hydroxide, sodium carbonate, potassium carbonate, calcium carbonate and lithium carbonate. Examples of suitable oxidizing and bleaching agents include sodium chlorite, hydrogen peroxide, and alkali metal hypochlorites such as sodium hypochlorite, potassium hypochlorite and lithium hypochlorite. Examples of suitable quaternary ammonium compounds include alkyl dimethyl benzyl ammonium chloride, alkyl dimethyl ethyl benzyl ammonium chloride and alkyl dimethyl ammonium saccharinate. An example of a suitable mixture of a surfactant and a chelating agent is a surfactant of any hydrophilic-lypophilic balance (HLB) number and a chelating agent such as ethylene diamine tetraacetic acid. Examples of suitable topically applied liquid medications and disinfectants include hydrogen peroxide, ethanol and isopropyl alcohol.

Examples of suitable commercially formulated liquid cleaners include “Rust Stain remover” by Whink Products Co., “Lime Away” by Reckitt Benkeiser, “Windex” by S.C. Johnson, Inc. and “Pine-Sol” by Clorox, Inc.

Examples of suitable lubricants include DW-40, distributed by DW-40 of San Diego, Calif. And Liquid Wrench Super Penetrant, distributed by Radiator Specialty Company of Charlotte, N.C. , Silicone multi-purpose Lubricant, distributed by CRC Industries, Inc. of Warminster, Pa. and Elmer's Slide -All with TEFLON Dry Spray lubricant, distributed by Borden, Inc., Dept. CP, Columbus Ohio

Examples of suitable commercially formulated household, industrial and agricultural chemicals include herbicides, pesticides and fungicides such as Hot-Shot Roach and Ant Killer, distributed by Spectrum Group of United Industries, Inc. Round-Up Weed and Grass Killer, Ready-to-Use, distributed by Monsanto Company Lawn and Garden Products of Marysville, Ohio, Weed-B-Gone, distributed by Ortho Group of Columbus, Ohio, Bug-B-Gone, distributed by Ortho Group of Columbus, Ohio, Triozicide, distributed by Spectrum Group of United Industry, Inc. of Saint Louis, Ohio, Ortho Garden Disease Control, distributed by Ortho Group of Columbus, Ohio.

Suitable surfactants include those selected from surfactant families which have hyrophilic-lypophilic (HLB) numbers suitable for converting the particular precursor liquid composition to fluid foam and are also compatible with the one or more primary active functional agents used. Examples of suitable surfactants for use with household cleaner compositions include cocoamine oxide, sodium alkyl alkanoate, and sodium dodecyl diphenyl disulfonate and mixtures thereof.

Suitable optional enhancing agents include fragrances, such as “Fresh”, “Rain Fresh”, “Floral”, “Lemon”, “Orange”, and “Citrus”. Other suitable enhancing agents include coloring material and surface shining agents, such as waxes, to enhance visual aesthetics, antibiotic agents to prevent wound infection, coagulating agents, such as alum (potassium aluminum sulfate), to stop skin bleeding.

Suitable optional additional compatible secondary active cleaning agents include antibacterial agents, antistatic agents, antisoil and antitstain agents, acaricides, antislip agents, fungicides, enzymes and biologically active agents.

Additionally the carrier fluid foam composition can include an override alkaline builder or buffer agent. The purpose of such a builder is to adjust composition solution pH in order to increase or decrease the rate of active agent decomposition as needed. For example it is desirable to increase the solution pH of active agents selected from the family of alkali metal hypochlorites in order to reduce their decomposition rates and extend their cleanability shelf life. In other instances it may be desirable to increase the solution pH in order to increase the chemical activity and cleanability of the active agent by increasing its rate of decomposition and as would be the case with hydrogen peroxide solution. Suitable override alkaline builders include sodium hydroxide, potassium hydroxide, lithium hydroxide, calcium hydroxide, sodium carbonate, potassium carbonate, lithium carbonate, sodium bicarbonate, potassium bicarbonate, lithium bicarbonate and calcium bicarbonate.

As shown in the Examples below, the present inventor found that the fluid foams disclosed herein provide better cleaning without scrubbing than other known cleaners he tested. Substantially the same superior cleaning results, as were obtained in the cleaning of the stain covered surfaces of the landscaping timbers, are obtained when the fluid foam cleaning compositions of the invention are applied to stained surfaces of painted wood, plastic film, cement, plaster, fabric or the like. In addition, the present cleaning composition carrier fluid foam, even without the inclusion of a fragrance, was found to mask to a substantial degree, the smell of some active cleaning agents such as sodium hypochlorite, acetic acid and ammonia. Also, during the application of the fluid foam cleaning composition of the invention to a stained surface, the typically opaque white color of the fluid foam provided an easily seen indicator of whether the cleaner had missed any particular area of the surface. The present inventor further found that the carrier fluid foam cleaner described herein floats, remains stable on water surface and continues to clean at the water/wall interface, as in toilet bowl cleaning.

Fluid foams having characteristics outside the combination of characteristics set forth above for the present carrier fluid foam exhibit a lower ability to clean and remove stains without brushing or scrubbing. For example, a thick liquid having high relative viscosity is not readily formed into a fluid foam cleaning composition of the invention and is not readily removable from a surface by rinsing. Typically, when such a thick liquid is used to clean a surface, scrubbing is required to remove a layer of the cleaner that remains on the surface even after rinsing. A fluid foam having very low syneresis value does not clean well because it does not carry and release an adequate amount of the active cleaning agent to the stained surface, even if the vertical clingability of the foam is high. Also, a foam that has an excessively large syneresis value often is too thin and slippery, which prevents the foam from adhering to the stained surface long enough to accomplish the cleaning. A foam having very short horizontal thickness half-life or a very low vertical surface clingability also leaves the stained surface too quickly to allow for adequate cleaning.

Producing and Dispensing Carrier Fluid Foam

The process for producing a functional fluid foam composition of the present disclosure typically comprises two-steps. First a solution is prepared containing an active agent, a compatible surfactant and other additives if desired, each in the desired concentrations recited herein before. Then the solution is vigorously agitated in the presence of a gas. The vigorous agitation can be achieved with mechanical stirrers, but preferably is provided by the fluidic/pneumatic action of a fluid jet, such as is produced by a mechanical breakup actuator of an aerosol dispenser in the presence of propellant. Preferably, the foam is produced with a low-boiling hydrocarbon propellant in an aerosol dispenser made of materials compatible with the solution. Suitable hydrocarbon propellants include propane, n-butane, isobutane and mixtures thereof in a concentration of 1 to 20% by the weight of the solution. Other suitable propellants include Dimethyl ether, 1,1-Difluoroethane, 1,1,1,2-Tetrafluoroethane, and mixtures thereof in a concentration of 1 to 20% by weight of the solution. Parts and surfaces of the aerosol dispenser that contact the solution are of active agent-compatible metal, rubber, glass or plastic.

An exemplary method of preparing and dispensing the present fluid foam will now be described with particular reference to the aerosol dispenser depicted in FIG. 2. A solution of active agent(s) and a surfactant, in accordance with the concentrations required for the fluid foam composition, is mixed and placed in the container of the aerosol dispenser. The outer wall of the dispenser container typically is of a metal, plastic or glass of sufficient strength to withstand the internal pressures expected during use. The container has optionally an inner liner made of active agent-compatible glass or plastic. Polyethylene, polypropylene, polyamides, polyethylene terephthalates, polyacetals, and polymer mixtures such as acetal-trioxane polymers, acrylonitrile-styrene polymers and acrylonitrile-methacrylate polymer are suitable liner materials. A preferred liner is that which is in intimate contact with the dispenser container inner wall as depicted in FIG. 2. A container particularly suited for use with the solutions is commercially available from ALCAN PACKAGING of ALgroup Wheaton of Netherlands. Another suitable container is a Pouch or Barrier Dispenser. This dispenser has a pouch suspended from the dispenser cover within the container and is not in intimate contact with the dispenser container inner wall.

Other exemplary aerosol dispensers suitable for the preparation and delivery of the carrier foam of this invention are similar to the dispenser depicted in FIG. 2 but without the inner liner 21 of the container 20 and optionally without the inner coating or laminate on the inside surface of the container cover 22 provided that the material of construction of the container 20 and the cover 22 are active-agent-compatible and pressure-resistant material. Such materials of construction include metals, glass, high performance plastic and reinforced plastic. Tin plate metal, carbon steel, stainless steel, tantalum metal, titanium metal, thick glass, glass-reinforced plastic, wire reinforced plastic and Kevlar® (trade mark for E.I. DuPont De Nemours & Co. high performance aramid Fiber) reinforced plastic are suitable materials of construction.

The aerosol dispenser, as depicted in FIG. 2, comprises a cylindrical container 20 having a cover (also called a “mounting cup”) 22 attached to the top of the container. The container has an inner liner insert 21 of active agent compatible material. Cover 22 has an active agent-compatible material laminated to its inner surface. Valve components of the aerosol dispenser are pre-assembled to form a valve assembly unit, which includes housing 23, valve stem gasket 24, spring 25, valve stem 26, actuator button 27 containing nozzle 28, and dip tube 29. The valve assembly unit is inserted through an opening in the center of cover 22 and is attached to the cover to form a valve/cover assembly. Then, the pre-assembled valve/cover assembly is installed in the container. The active cleaning agent-compatible material laminated to the circumferencial edge of cover 22 is brought into contact with the upper rim of active agent-compatible inner liner 21 of container 20 and then the circumferencial edge of cover 22 and the top edge of container 20 are mechanically crimped together, so that the active agent-compatible materials of the cover laminate and the container inner liner form a seal. Optionally, a cover-sealing gasket, not shown in FIG. 2, can be installed. All parts of the aerosol dispenser are made of materials compatible with the liquid.

A suitable design of spray valve assembly for installation in the cover of the aerosol dispenser is commercially available from Precision Valve Corporation, Yonkers, N.Y. or from Seaquist Perfect Dispensing of Gary, Ind. In such spray valve assemblies, the housing and valve stem can be made of nylon, the dip tube and actuator button of polyethylene or polypropylene, the valve stem gasket, of an ethylene/propylene copolymer or of Viton® synthetic rubber (from Dupont Dow Elastomers LLC of Wilmington, Del.) and the coil spring of passivated stainless steel, tantalum or titanium. Typically, the cylindrical container and cover can be made of aluminum, steel (such as carbon steel or stainless steel), tin plate, tantalum, titanium, thick glass, glass re-inforced plastic, wire re-inforced plastic or Kevlar® (a TradeMark for E.I. DuPont De Nemours & Co. high performance aramid fiber), the cover being laminated with a film of polyethylene or polypropylene on its inner surfaces and the cylinder having an inner liner insert of polyethylene or polypropylene.

A precursor solution is prepared and mixed. Then the dispenser container is loaded with the solution either by pouring prior to installing the cover and valve spray assembly or by injecting the solution under pressure through the installed cover and spray valve assembly. After the dispenser container is loaded with solution and the cover and spray valve assembly installed and sealed, propellant (usually as liquid) is injected under pressure through the valve assembly into the container where part mixes with solution 30, part floats as a liquid layer 50, atop the solution, and part forms a gaseous phase that fills pace 40, thereby providing the pressure needed to drive the solution/propellant mix through the valve assembly when the valve is opened. Suitable propellants include propane, butane, isobutane and mixtures thereof in quantities amounting to 1 to 20% of the weight of the solution among others mentioned above. Other suitable propellants include Diethyl ether, 1,1,-difluoromethane, 1,1,1,2-Tetrafluoroethane and mixtures thereof in quantities amounting to 1 to 20% of the weight of the aqueous solution. Before opening the valve, the dispenser is shaken to mix the propellant with the aqueous liquid in the container. Then, depressing actuator button 27 against spring 25 causes gasket 24 to flex and expose the orifices in the wall of valve stem 26 to pressure and allows the mix of cleaning composition solution and liquid propellant to flow through valve stem 26, through the passages of button actuator 27 and through nozzle 28. Nozzle 28 has a mechanical break-up actuator insert located just upstream of the nozzle exit. Typically, the mixture emerging from the actuator nozzle is like a mist that when dispensed onto a surface, converts almost immediately to fluid foam of the invention.

Within the actuators of the aerosol dispensers, certain design features can improve sprayed foam formation. Such features include, upstream of the exit nozzle, mechanical breakup mechanisms to reduce spray particle size. Typical break-up mechanisms include a circular or near circular swirl chamber, one or more tangential entries to a chamber, orifices, screens, and/or special exit nozzles. The aerosol dispenser can also include an extension tube, not shown in FIG. 2, which extends from the exit of button 27 and has a mechanical break-up orifice located at the exit end of the extension tube.

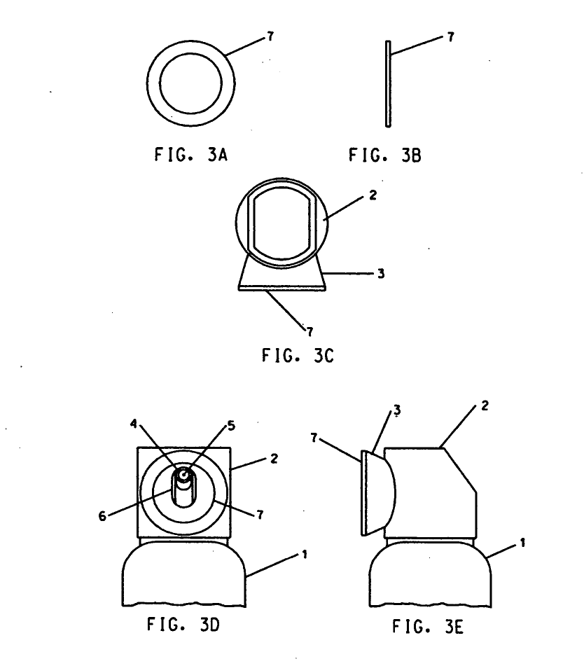

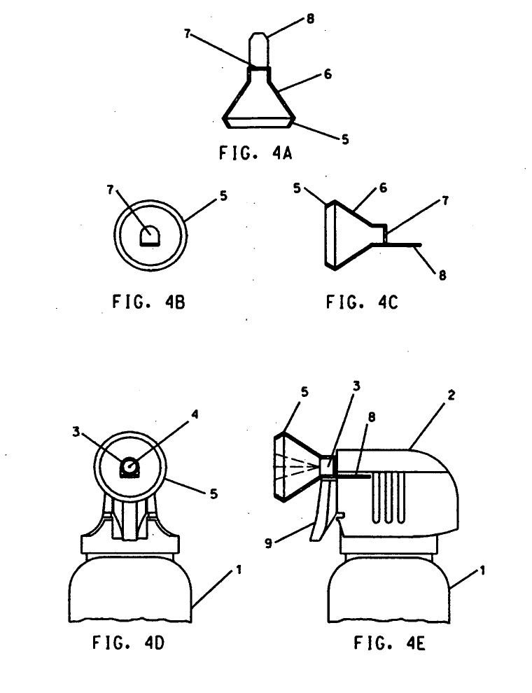

The aerosol dispenser can further include foam drip catcher device as described in FIGS. 3A to 3F and FIGS. 4A to 4F to collect residual foam oozing out of the nozzle after the valve is shut off. FIG. 3A is a front view, and FIG. 3B is a side view of schematic representations of a foam drip catcher dam 7 which is designed to be attached to the front end of the horn 3 of the Sirena® Integrated Spray Cap shown in top view in FIG. 3C, in front view in FIG. 3D and in side view in FIG. 3E. Sirena Integrated Spray Cap is in turn mounted on the valve stem 26 of FIG. 2 and is locked in place over the dispenser cylindrical container 1 of FIG. 3D and FIG. 3E. Attaching the foam drip catcher dam to the horn of a Sirena Spray Cap converts it, from being a side shield around the spray jet, to a chamber suitable for catching foam drips. FIG. 3C, FIG. 3D, and FIG. 3E show the location of the drip catcher dam 7 relative to the dispenser can 1, Sirena Spray Cap housing 2, Sirena horn 3, actuator 5, nozzle 4 and horn back opening 6. The latter allows the nozzle to move up or down.

FIG. 4A is a top view, FIG. 4B is a front view and FIG. 4C is a side view of schematic representations of a foam drip catcher chamber designed to be attached to ACC-U-SOL Sprayer as sown in FIG. 4D and FIG. 4E, wherein 1 is an aerosol dispenser can, 2 is an ACC-U-SOL Sprayer, 3 is a nozzle, 4 is an actuator, 5 is a foam drip catcher chamber dam, 6 is a drip catcher chamber, 7 is a back opening of the drip catcher chamber, 8 is a rear arm for mounting the drip catcher chamber onto the ACC-U-SOL Sprayer by sliding it into the space between the nozzle 3 and the top end of the finger trigger, and 9 is a finger trigger.

### EXAMPLES

The following examples illustrate the preparation of several carrier fluid foam compositions of this disclosure and demonstrate the unexpectedly large advantage in enhancing the functional performance that these carrier fluid foams possess over known products with the same or similar active agent functionality but in forms other than the carrier fluid foam of this invention. The reported results are believed to be fully representative of the invention with particular emphasis being made on the end use application areas of household cleaning, disinfecting and medicinal applications, but do not constitute all the tests involving these end use applications. The inventor believes that the same carrier fluid foam technology disclosed here is equally applicable to other end use application areas including lubrication, agricultural chemicals, industrial chemicals, cosmetic chemicals, institutional cleaning chemicals and pharmaceutical end uses. The same good enhancement in performance is expected to result in these other end uses when the same active agent(s) or an active agent(s) with similar functionality is used in the form of the carrier fluid foam of this invention as compared with the liquid form itself. The reason for this expectation is that the functionality improvements obtained with the carrier foams of this invention are the direct results of the physical properties of the foam itself and are independent of the specific physical and chemical properties of the functional active agent used. All that is needed is to select the surfactant with the appropriate HLB number, which converts the precursor liquid composition to the carrier foam of this invention when such liquid composition is vigorously agitated in the presence of gas.

In the Examples, carrier fluid foam of the present disclosure was produced by vigorously agitating solution containing a compatible surfactant and the active agent(s), while in contact with a gas, such as air, or a low boiling liquid hydrocarbon propellant. Vigorous agitation was produced by mechanical or fluidic/pneumatic means. Test foams of the invention prepared by vigorous mechanical agitation of liquid solution in the presence of air were produced in an 800-watt AC “Osterizer”, manufactured by Oster Corporation of Milwaukee, Wis., having a 1.2-liter-capacity glass container. The foam produced by the Osterizer was dispensed to a test panel surface by pouring, by brushing or with a spatula. When vigorous agitation was provided by an aerosol dispenser, a dispenser of the general type illustrated in FIG. 2 was employed. When a commercial cleaning composition was tested, the commercial product was employed in accordance with its manufacturer's instructions and usually applied to the test surface with the manufacturer-supplied plastic hand pumped spray nozzle or other dispensing means.

The Examples demonstrate that hand pumped dispensers of the type common in the art have difficulty providing sufficiently intense mechanical agitation to produce a carrier fluid foam of the present disclosure. They also demonstrate that even the currently available commercial foams produced by aerosol sprays have difficulty producing carrier foam of the present disclosure. Example 26 summarizes the foam properties of typical current commercial cleaner products evaluated in the Examples. Example 27 summarizes the foam properties of the carrier foams of the present disclosure demonstrated in the Examples.

### Example 1

This example along with Example 2 illustrates the formation of a carrier fluid foam product using hydrogen peroxide as the active cleaning and disinfecting agent. Such carrier foam product should be useful in medicinal applications such as cleansing and simultaneously disinfecting dirty wounds, without scrubbing, and also in cosmetic applications such as in hair dyeing where the oxidizing power of the active agent helps bleach the hair before dyeing. In addition, it can be used in special cleaning applications to remove stains of blood and other organic material.

To a 100 ml commercially available, 3% hydrogen peroxide solution in water, was added 3 ml of 30% aqueous solution of non-ionic surfactant “Barlox 12” cocamine oxide (available from Lonza Specialty Chemical company of New Jersey). The surfactant has an average molecular weight of 249 and is a mixture of N,N dimethyl-1-dodcylamine-N-oxide, N,N-dimethyl-1-tetradecyl-amine-N-oxide, and N,N dimthyl-1-hexadecyl amine-N-oxide. This precursor solution has 3% active agent and 0.9% surfactant (dry basis) with a pH of 3.5. Upon vigorous agitation in the Osterizer at a “Whip” setting for 20 seconds the carrier fluid foam was produced. Measurement of mildew cleanability with 10 minutes treatment time on the landscaping timber, showed no bleaching action at all with a cleanability rating of zero.

### Example 2

This example illustrates the effect of the concentration the active ingredient, hydrogen peroxide, on foam characteristics and mildew cleanability rating. A series of three 100 ml precursor solutions were prepared with hydrogen peroxide concentrations of 8.8%, 17.7% and 35.4% using 1.5% cocamine oxide surfactant (dry basis). Theywere whipped in the Osterizer for 30 seconds. The resulting foam properties and cleanabilities of mildew stains on landscaping timber were then measured. The results, which are summarized in Table I, show that good foam properties were obtained in all cases. However, only at the highest concentration used (35.4%), was there any change in color of the mildew stained landscaping timber. The color contrast cleanability rating was 3.5. The treated panel surface changed from gray/black to a reddish color. This degree of color change did not occur immediately upon rinsing with water after 10 minutes. Instead it developed slowly over two hours after rinsing with water. It is known that hydrogen peroxide decomposes to water and oxygen faster at higher solution pH. Therefore it is expected that stronger and faster cleaning actions will be obtained by adjusting the solution pH to higher levels.

TABLE I
Properties of hydrogen peroxide carrier
foam at different concentrations

| Concen- | | | horizontal | | Cleanability |
|---|---|---|---|---|---|
| tration | | Clingability | thickness | Syneresis | color |
| (%) | PH | (min.) | half life (min.) | (%) | difference |
| 8.8 | 5-6 | 11.5 | >44 | 20.5 | 0.0 |
| 17.7 | 2-4 | — | >66 | 15.5 | 0.0 |
| 35.4 | 4-5 | 21.0 | >26 | 19.5 | 3.5 |

This example along with Example 4 illustrates the preparation of carrier foams in which the active ingredients are rust removers and it demonstrates the effectiveness of these products in removing rust stains in household environments.

In this example a commercial “Rust Stain Remover” liquid solution with unspecified ingredients and a pH of 1.0 (available from Whink Products Company of Eldora, Iowa), was used as the active cleaning agent without further dilution. Cocamine oxide surfactant was added at a concentration of 0.4% (dry basis) and the mixture was vigorously agitated in the Osterizer as in Example 1 to produce the carrier fluid foam for this rust removing formula. With the use of a spatula, the carrier fluid foam was applied to: (1) a toilet bowl surface stained with yellow rusty color and (2) to sink drain which has crusty rust build up around the metal drain seal. The two stained locations were rinsed with water after 10 minutes without scrubbing. The toilet bowl was found to be completely free of the yellow color. However only one half of the drain crusty deposits was eliminated. The toilet bowl stains were also removed by applying the liquid formula itself using a Q-tip with mild scrubbing.

### Example 4

An aqueous solution was prepared which contains 6.3% oxalic acid and 6.5% cocamine oxide surfactant (dry basis). An amount of 135 g. of this solution was charged into a 40×156 mm. aerosol dispenser of the type illustrated in FIG. 2. Then an amount of 7 grams of NP-31 propellant was injected into the dispenser under pressure. The foam produced from the filled and shaken dispenser had these properties: a pH of 1.0, a horizontal thickness half life of 9 minutes, a clingability of 11.5 minutes and a synerisis of 8%. When this foam was sprayed on orange colored rust stains on the porcelain surfaces of a kitchen sink and a bathroom tub and was allowed to stay on for one hour before rinsing with water, the orange stains were completely eliminated. However when this foam product was applied, for an hour, on a metal washer mounted on the bottom of a bathroom wash sink, which developed several dark brown, thick, and crusty rusty spots around the washer, it reduced the intensity of the rust spots but it did not eliminate them. This suggests that more than one application will be needed to clean such heavy rust spots.

### Example 5

This example, along with Examples 6, 7 and 8, illustrates the use of selected organic acids as the active ingredients to remove stains made of soap scum, hard water deposits and calcium deposits effectively and without scrubbing.

In this example, the active cleaning agent was acetic acid in the form of a commercial “Distilled White Vinegar” product (diluted with water to 5% acid strength). This solution had a pH of 1.5. The surfactant was also Barlox-12 cocamine oxide used at 1% concentration and the batch volume was 103 ml to which 8 drops of “Fresh” fragrance was added. The Osterizer produced carrier foam of this active cleaning agent was evaluated as a remover of calcium deposits. In this test, the fluid foam was poured onto the plastic water collection trough found under the water/ice dispenser of a house refrigerator. The plastic grid cover to the trough was also covered with the fluid foam. After 40 minutes the remaining liquid and foam were blotted out and the surfaces were wiped with paper towel. Both the grid and the bottom of the trough, which were covered with heavy calcium deposits at the start of the test, were found to be thoroughly clean and shiny. Previous to this experiment it used to take several hours of treatment with liquid vinegar alone to achieve this level of cleaning.

### Example 6

A precursor solution was prepared from acetic acid, in the form of commercially sold distilled vinegar at 5% acid strength with a measured pH of 1.5, as the active cleaning agent. The solution consisted of 4.7% acetic acid and 2.1% Barlox-12 cocamine oxide surfactant (dry basis) with 10 drops of “Fresh” fragrance added to a total batch size of 215 ml. The Osterizer produced foam had a syneresis of 22% and a horizontal thickness half-life of 15 minutes. This carrier fluid foam was applied gently, with a fine bristles paint brush, on the inside surface of a shower glass door stained with white looking soap scum. After one hour, it was rinsed with water. The white deposit color disappeared. However in one treated area there remained a uniform translucent layer, which did not rinse away with water but could be easily wiped by hand or paper towel while wet. This suggested that the foam application was left too long before rinsing, which allowed the reaction products of the c leaning process to dry up and r e-coalesce into a thin gel-like layer and that a shorter treatment time would be better.

### Example 7

This example is an extension of Example 6 showing that rinsing the treated area before it dries up improves cleanability performance. A precursor solution with 4.5% acetic acid, as the active agent, and 2.7% Barlox-12 cocamine oxide surfactant was converted to a carrier fluid foam by vigorous agitation in the Osterizer. The foam had a syneresis of 30% and horizontal thickness half-life of 15 minutes. As in Example 6, the foam was applied on another soap scum stained area of the same bathroom shower door and this time it was rinsed with water only after 10 minutes from application. Upon drying, the glass surface was completely clean, shiny, transparent and free of white color deposits. Scraping the cleaned surface with a razor blade produced nothing as compared with the untreated area where scraping produced white material hanging at the blade edge.

In another control experiment, the 5% acetic acid solution itself was applied on another stained area of the shower glass door by pouring the liquid directly from the bottle on the stained area and rinsing after 10 minutes from application. The resulting surface was only partially clean with the appearance of reduced, but not eliminated opacity and reduced amounts of razor blade scrapings. This example illustrates the cleaning enhancement benefits obtained when a fluid cleaner is used in the form of the carrier fluid foam of this invention.

### Example 8

This example illustrates the use of another organic acid, as the active agent for the preparation of carrier foam product for the removal of soap scum. An aqueous precursor solution containing 8% citric acid and 6.3% cocamine oxide surfactant (dry basis) was first prepared. Then an amount of 135 gram of this solution was charged to an 40mm×156 mm. aerosol dispenser of the type illustrated in FIG. 2. An amount of 7 g. of NP-31 propellant was then injected into the dispenser under pressure. The carrier foam from this dispenser was then sprayed on the shower glass door, which was covered by vertical streaks of soap scum. The sprayed test area was limited to 7.6 cm.×3.8 cm. (3.0 in.×1.5 in) by a template designed to delineate sharp boundaries. After 10 minutes, the treated area was rinsed with water leaving behind a clear and transparent surface compared to the opaque surrounding area, which was covered with soap sum. The treated area was clear when examined under wet as well as dry conditions. Following this initial small area test, the entire glass door surface, covered by soap scum, was sprayed with this carrier foam and was rinsed 10 minutes later leaving behind a perfectly clean and transparent surface. The properties of this carrier foam were: pH=1, vertical area clingability=19 minutes, horizontal area coverage half life=21 minutes and syneresis=14.5%

### Example 9

This is a cleaner product called “Lime Away” distributed by Reckitt Beckeiser, Inc. of New Jersey. It is claimed to remove lime, calcium and rust. Its is delivered by a finger trigger foam pump dispenser valve from a plastic bottle. Its pH was zero (0.0). When this foam is applied on soap scum deposit areas next to those on the vertical shower glass door of the bath room described in Examples 6 to 8 and rinsed after the same period of time, no cleanability improvement whatsoever was observed. By contrast, the carrier foam products described in Example 6 removed soap scum and calcium deposit stains completely in the same treatment periods without scrubbing.

### Example 10

This example illustrates the difference, in key foam properties, between the carrier fluid foam of this invention and the foam of an existing commercial cleaner product delivered by an aerosol dispenser. The product is “Scrubbing Bubbles” (distributed by S.C. Johnson, Inc.). The active ingredients in this product are: n-alkyl (60% C 14, 30%C16, 5% C18) dimethyl benzyl ammonium chlorides (0.11%), n-alkyl (68%C12, 32% C14, dimethyl ethyl benzyl ammonium chloride (0.11%), inert ingredients and 6% hydrocarbon propellant, with a measured pH=12. The measured foam properties of this product are: horizontal thickness half-life=9 minutes and vertical surface clingability=2 minutes.

### Example 11

This product is “Orange Clean—Degreasing foam” (produced by Orange Glo International, Inc. of Colorado). Its pH was measured at 7. It is delivered from an aerosol dispenser as thick foam. However the foam properties are found to be far outside the range of the carrier fluid foam of the present disclosure. Specifically, the horizontal thickness half life was 5.5 minutes, the vertical clingability was 3 minutes and the syneresis was 0.6%

This product foam, the label of which claims to degrease stained surfaces, was tested on oven grease stains. An oven rack grill/pan set, heavily stained with baked grease stains, which accumulated over a period of time from repeated baking, was taken out of the oven and placed on a horizontal plane with the steel grill placed over the aluminum pan. The foam from this cleaner was sprayed over one quadrant of the exposed area of the set in sufficient quantities to form a foam layer about an inch thick covering both the pan and the grill. After about 40 minutes, the pan and the grill were rinsed with water and dried without scrubbing. Comparing the treated quadrant with the adjacent untreated quadrant showed no difference between them in the intensity and distribution of stains.

### Example 12

In this example a carrier fluid foam cleaner was prepared in the Osterizer from a precursor solution consisting of 16% sodium hydroxide as the active agent and 1.8% Barlox-12 cocamine oxide surfactant (dry basis). This carrier fluid foam, which had a syneresis of 26% and a horizontal thickness half life of 31 minutes, was applied on a second quadrant of the stained oven grill/pan set and in the same manner as described in example 11. After 35 minutes the pan and the grill were rinsed with water without scrubbing and dried. The treated grill area became shiny clean and free from stains. Similarly the treated area of the aluminum pan was also completely free of stains. However the aluminum pan was covered with a very thin gray dusty layer, which could easily be removed by gentle dry or wet wiping. This dusty material is believed to be a reaction product of sodium hydroxide with aluminum surface. The wiped surface of the pan was shiny and completely free of stains.

### Example 13

An aqueous solution was prepared comprising 14% sodium hydroxide and 5% Barlox-12 cocamine oxide (dry basis). A 135 g. of this solution was poured into a 40 mm.×156 mm. aerosol dispenser of the type illustrated in FIG. 2. The mounting cup was installed and an amount of 7 g. NP-31 propellant was injected under pressure. The foam product from this dispenser was compared, side by side, with a commercial foam product, also delivered from an aerosol dispenser, called “Easy-Off, Fume Free Max Oven cleaner, distributed by Reckitt Benckeiser, in its ability to remove baked grease stains. The active ingredient in Easy-Off is monoethanolamine. A grease stained aluminum drip pan from a household oven and a porcelain rim of an electrically heated flat burner in a kitchen range were used in this test. Through normal use, these two items were covered with multitudes of dark brown baked grease spots. The drip pan was in a horizontal orientation. The two product foams were sprayed on equal size neighboring areas of about 7.0 cm.×3.5 cm. each, first on the pan and then on the porcelain rim of the burner. After 46 minutes the treated areas were wiped with paper towels. Visual examination of the drip pan showed that: where the applied layer of the carrier foam was thick, the cleaning was thorough. Where it was thinner the cleaning was partial and equal to that obtained with Easy-Off commercial product. On the burner porcelain rim, the area treated with the carrier foam was thoroughly cleaned while the area treated with Easy-Off commercial product was only partially cleaned leaving behind about 75% of the stain spots intact. The properties of the two foam products were compared. The results are shown in table II blow.

TABLE II
Property comparison between grease remover
carrier foam of this invention and
Easy-Off Oven cleaner commercial product

| | | | horizontal | | |
|---|---|---|---|---|---|
| | | Clingability | thickness | Syneresis | Water |
| Product | pH | (min.) | half life (min.) | (%) | Rinsability |
| Carrier foam | 14 | 64 | >140 | 3.5 | 100% |
| Easy-off | 14 | >70 | 1.0 | ˜7.5 | 0.0% |

It was noted that the carrier foam of this example rinsed out easily with water. It also separated into a distinct layer of foam and a distinct layer of clear solution in the horizontal thickness life test beaker. By contrast, the foam of Easy-Off product dried up on the drip pan, did not rinse out with water and did not separate into two clearly distinct foam and liquid layers in the horizontal thickness life test beaker. Both layers contained gas bubbles suspended in liquid phases. There were more bubbles settled in the upper layer and less bubble settled in the lower layer making for hazy, unclear interfaces. Further, in the vertical clingability test, the residual foam of Easy-Off on the landscaping timber not only did not rinse out with water but it also could not be removed by hard wiping with paper towel.

### Example 14

In this example the same two products compared in Example 13 were compared again in their ability to remove baked grease stains, but under different conditions. A steel rack grill from the same household oven heavily stained with dark brown grease stains, a different area of the same grease stained drip pan and a different area of the same grease stained porcelain burner rim as in Example 13 were used in this example. The grill was placed over and in contact with the drip pan. The grill/pan set was placed in a vertical orientation and the two product foams were sprayed on equal size neighboring areas of about 10 cm.×10 cm. each. The porcelain rim of the burner was treated in a horizontal orientation in the same manner as in Example 13. After 46 minutes the treated areas were rinsed with water and wiped with paper towels. The steel grill and the burner porcelain rim were thoroughly cleaned by the carrier foam of his invention. They were cleaned only to about 25% (based on number of grease spots remaining) with Easy-Off product. The drip pan area was cleaned to about 90% by the carrier foam product of this example and only to about 35% by the Easy-Off product

### Example 15

This example along with Examples 16 and 17 illustrate the use of sodium chlorite as a mild bleaching active agent in carrier foam of the present disclosure.

A precursor solution of bleaching agent, sodium chlorite, was prepared by dissolving the solid material in water and adding Barlox-12 cocamine oxide surfactant at formula concentrations of 8.5% sodium chlorite and 1.5% cocamine oxide (dry basis). A carrier fluid cleaning foam produced from this solution by the Osterizer had a synerisis of 18% and a horizontal thickness half-life greater than 50 minutes. This foam was tested for mildew stain cleanability on a stained landscaping timber. The cleanability after 10 minutes application time followed by rinsing with water and drying thoroughly, was 4 color units. The same carrier foam was applied on a concrete surface stained with mildew at the green color stage and allowed to dry without rinsing. This treated concrete area was found to be completely clean 24 hours after application.

### Example 16

This example is similar to that of Example 15 except that the precursor formula concentrations were higher, 27% sodium chlorite as the active agent, and 3.6% Barlox-12 cocamine oxide surfactant (dry basis). The Osterizer produced foam had a syneresis of 23% and a horizontal thickness half-life of more than 45 minutes. The mildew cleanability rating on a gray stained landscaping timber, with 10 minutes treatment time was 9.6 color units. As a control, the 10 minute cleanability rating of the sodium chlorite solution itself, prior to the addition of surfactant, was only 2 color units when applied on the same landscaping timber. It was observed in both Examples 15 and 16 that the bleaching action was very slow and continued after rinsing with the treated panel becoming cleaner by the hour. The cleanability data reported here were measured 24 hours after rising when the panels were completely dry. Also, the bleaching action spread uniformly and horizontally beyond the area width originally covered by the applied foam. This example, taken along with Example 15, show that the cleanability of this sodium chlorite as active agent, increases substantially with the use of the carrier fluid foam at the same liquid concentration. The cleanability improved further with increased concentration.

### Example 17

In contrast with the previous two examples, in which the active agent, sodium chlorite sample was about five years old, the active agent in this example was also sodium chlorite but it was produced more recently. The aqueous foam precursor solution contained 10% sodium chlorite and 1.5 Barlox-12 cocamine oxide (dry basis). The foam was produced by whipping this solution in the Osterizer for 30 seconds. The horizontal surface half-life was greater then 55 minutes and the cleanability rating was 3.5. As in examples 15 and 16, the foam spread horizontally beyond panel boundaries to about twice the original width. It removed the gray colored mildew stain layer. It left behind a pinkish color surface on the landscaping timber but did not bleach the wood surface as does the active agent sodium hypochlorite.

### Example 18

This example illustrates the conversion of a commercially formulated cleaner liquid to the present carrier foam in order to enhance its performance. The product is “Windex Window Cleaner” (distributed by S.C. Johnson, Inc.). A precursor solution formula was prepared using 200 ml of Windex liquid as the active agent and 15 ml Barlox-12 surfactant (liquid basis). The calculated concentrations are 93% Windex solution an 2.1% Barlox-12 cocamine oxide (dry basis) The Osterizer-produced carrier foam had a syneresis of 19% and a horizontal thickness half life greater than 50 minutes. The enhancement is in the form of providing the additional cleaning function of detergent action and also the ability of the carrier foam to be applied to a vertical surface so that it clings for sufficiently long time to clean the stained surface without dripping.

### Example 19

This is another example illustrating the conversion of a commercially formulated cleaner liquid to the carrier foam of this invention in order to enhance its performance. The product is “pine-sol-Cleaner and Antibacterial”(Distributed by Clorox, Inc. of Oakland, Calif.). This formula as purchased, already has an efficient surfactant in it. By agitating the liquid itself vigorously in the Osterizer without the addition of more surfactant, carrier fluid foam was produced with a syneresis of 29% and a horizontal thickness half-life of more than 47 minutes. By the addition of 2.5% Barlox-12 cocamine oxide surfactant (dry basis), the new carrier fluid foam had a syneresis of 20% and a horizontal thickness half-life of more than 28 minutes. The enhancement in this example is the ability of this carrier foam to adhere to and cling to a vertical surface for long enough time to clean stains and to disinfect more effectively.

### Example 20

In this example and in the following Examples 21 and 22, The active agent in the carrier precursor solution is sodium hypochlorite.

To a 100 ml. of Clorox bleach solution containing 6% sodium hypochlorite, was added 1.0 ml of Barlox-12 solution containing 0.3 g. cocamine oxide (dry basis) as surfactant and 0.5 g. sodium hydroxide as an override alkaline builder. The solution was whipped for only 10 seconds in the Osterizer. The resulting carrier foam had a pH of 14, a horizontal thickness half-life greater than 47 minutes, a syneresis of 37%, a foam vertical clingability of 5 minutes and a 10 minute cleanability of 14.

### Example 21

The carrier foam of this example is produced under the same conditions as in Example 20 except that the Barlox-12 surfactant amount was 5.0 ml. equivalent to 1.5 g. cocamine oxide (dry basis) and the whipping time in the Osterizer was 5 seconds only. The resulting carrier foam had a pH of 14, a horizontal thickness half-life longer than 28 minutes, a syneresis of 21%, a foam vertical clingability of 7 minutes and a 10 minute cleanability of 14.

### Example 22

The carrier foam of this example is produced under the same conditions as in Example 21 except that sodium hydroxide was not added to the foam precursor solution and the whipping time in the Osterizer was 30 seconds. The resulting carrier foam had a pH of 11-12, a horizontal thickness half-life longer than 40 minutes, a syneresis of 17%, a foam vertical clingability of 29 minutes and a 10 minute cleanability of 14.

### Example 23

This example illustrates the role of alkali builder override substances in extending the shelf life of the carrier foam mildew remover product.

A 1090 ml. precursor carrier foam solution was prepared from 1000 ml. aqueous solution of sodium hypochlorite at 6% concentration and 90 ml of Barlox-12 surfactant containing 3 0% cocamine o xide (dry basis). Each of several aerosol dispensers of the type illustrated in FIG. 2 was filled with 144 g. of this liquid formula and 6 drops of “Lemon Bleach Fragrance. W.S.” supplied by Aromatic Fragrance & Flavors International, Inc. of Marietta, Ga., USA. Following the installation of the mounting cup and valve system, an amount of 4 g. of NP-31 propellant was injected under pressure. The average properties of the foam delivered from these dispensers soon after filling was typically as follows: sodium hypochlorite concentration=5.5%, pH=11.5, Foam vertical clingability=16 minutes, Syneresis=19% and cleanability=14. However after a relatively short shelf storage life of 40 days the performance properties of the foam delivered from these dispensers dropped sharply to: solution pH=9.25, sodium hypochlorite concentration=1.6%, and cleanability=4.4. This sharp drop in performance properties over such a short time resulted from the decomposition of sodium hypochlorite, in the absence of override alkali builder in the solution formula. The presence of alkali builder to bring the initial solution pH to 14 would have extended the performance shelf life substantially. A similar precursor solution formula to which sodium hydroxide was added at a level of 0.5%, as alkali builder, started at foam properties similar to the above formula except for the pH which stared at 14 instead of 11.5. As a result, the chemical stability of the carrier foam, improved by more than 10 folds. Instead of 40 days, it took this formula more than 400 days before its foam properties dropped to levels comparable to those obtained at 40 days shelf life without alkali builder override. Specifically the properties dropped to: pH =12.8, sodium hypochlorite concentration to 2.99% and the cleanability rating to 4.8.

### Example 24

It is well known that aerosol foam dispensers continue to ooze out a small amount of foam immediately after use, while the valve is in the off position. This example demonstrates the construction and use of the invention of two foam drip catcher devices which can be attached to existing aerosol spray caps in order to collect the foam residue which oozes out of the dispenser nozzle immediately after use, while the valve is in the off position, and prevents it from dripping on the hand or on other surfaces.

The first drip catcher demonstration was carried out using a Sirena Integrated Spray Cap as illustrated in FIGS. 3A to 3E, whereby flat ring 7 of FIG. 3A and FIG. 3B is attached to the front end of the Sirena horn 3 of FIG. 3C to act as a dam 7, which would stop the foam oozing out of nozzle 4 in FIG. 3D from sliding down and out of the collection chamber formed by the horn/dam system. In actual demonstration the inventor found that the foam oozing out of the nozzle, after turning the valve off, amounts to about two cubic centimeters and is normally held behind the dam, inside the collection chamber. Further the inventor found that this residual foam can either be rinsed away or left inside the collection chamber to dry on its own. The dried residue has negligible volume and does not adversely affect the performance of the nozzle in subsequent uses. In commercial use of this type of foam drip catcher, the dam ring 7 would be expected to be molded as an integral part of the horn of the spray cap. In a preferred embodiment, the requirements for the foam drip catcher include: (1) the chamber must be sufficiently large and the dam be sufficiently wide to hold the foam drip oozing out residue, (2) the front opening of the foam drip catcher be sufficiently large and properly aligned with the nozzle spraying position in order for the expanding foam jet to pass through the chamber freely, without touching the dam edges and (3) the material of construction be compatible with the foam delivered from the nozzle.

### Example 25

The second drip catcher demonstration was carried out using ACC-U-SOL Sprayer as illustrated in FIGS. 4A to 4E. In this example the foam drip catcher illustrated in FIG. 4A, FIG. 4B and FIG. 4C was first constructed whereby 5 is the dam, 6 is the collection chamber, 7 is the rear opening which fits around the ACC-U-SOL nozzle 3 of FIGS. 4D and 4E, and 8 is a rear arm. In use the rear arm is slipped snuggly in the narrow space between the nozzle 3 and the upper flat end of the finger trigger 9 of FIG. 4E, to attach it to the ACC-U-SOL Sprayer where it is held in place during use. A second method for attaching the foam drip catcher of FIG. 4C is to permanently mold the rear arm 8 as part of the top end of the finger trigger. In a preferred embodiment, the requirements for the foam drip catcher are the same as those mentioned in Example 24 above, namely: (1) the chamber must be sufficiently large and the dam be sufficiently wide to hold the foam drip oozing out residue; (2) the front opening of the foam drip catcher be sufficiently large and properly aligned with the nozzle spraying position in order for the expanding foam jet to pass through the chamber freely, without touching the dam edges; and (3) the material of construction be compatible with the foam delivered from the nozzle.

### Example 26

In this example the foam properties of several representative commercial household cleaners, some of which were cited in the above examples, were measured as they were delivered from their dispensers. Some were delivered using aerosol dispensers and some using a finger trigger pump sprayer. These products are listed below:
A. Professional Easy-off Fume Free Max Oven Cleaner distributed by Reckitt Benckiser, Inc. of Wayne, N.J., U.S.A
B. Orange Clean Degreasing Foam, distributed by Orange Glo International, Inc. of Littleton, Colo., U.S.A.
C. One-Wipe Bathroom Cleaner, distributed by Guardsman Product, Inc. of Grand Rapids, Mich., U.S.A.
D. Scrubbing Bubbles Bathroom Cleaner-Lemon- Removes Soap Scum Easily, distributed by S.C. Johnson & Son of Racine Wis., U.S.A.
E. Scrubbing Bubbles Mildew Stain Remover-Cleans Soap Scum, distributed by S.C. Johnson & Son of Racine Wis., U.S.A.
F. Pine-Sol Cleaner and Antibacterial, Distributed by Clorox Co. of Oakland, Calif., U.S.A.
G. Tilex Mildew Root, distributed by Clorox Co. of Oakland, Calif., U.S.A.
H. Lysol, Disinfectant, All Purpose Cleaner, Cuts Grease, distributed by Reckitt & Colman, Inc. Wayne, N.J., U.S.A.

The foam properties of these household cleaners are presented in Table III below:

TABLE III
Foam properties of typical commercial household cleaner products

| | | | | horizontal | |
|---|---|---|---|---|---|
| | | | Clingability | thickness | Syneresis |
| Product | Sprayer | pH | (min.) | half life (min.) | (%) |
| A(*) | aerosol | 14 | >70 | 1.0 | 17 |
| B | aerosol | 5 | 3 | 5 | 0.6 |
| C | aerosol | 12 | 3 | 11 | 7 |
| D | aerosol | 11 | 1 | 11 | 14 |
| E | finger pump | 14 | 0.1 | 3.5 | 8 |
| F | finger pump | 11 | 0.1 | >49 | 23 |
| G | finger pump | 14 | 0.5 | 6 | 14 |
| H | finger pump | 14 | 1 | 5 | — |

(*)The sprayed foam from this product was viscous. It adhered to the vertical surface and the dried and collapsed foam cells would not rinse with water. In the horizontal thickness beaker test, it did not separate into a clear foam layer and a clear liquid layer. Both layers contained a liquid phase in which bubbles were suspended. It was difficult to discern a phase boundary.

### Example 27

In this example the foam properties of the carrier foam products disclosed herein are summarized in Table IV below for easy comparison with the commercial products of Example 26.

TABLE IV
Foam properties of products of this invention

| Ex- | | | | | Horizontal | |
|---|---|---|---|---|---|---|
| am- | | | | | thickness | |
| ple | | Produced | | Clingability | Half life | Syneresis |
| No. | Stain | By | pH | (min.) | (min.) | (%) |
| 4 | Rust | aerosol | 1 | 11.5 | 9 | 8.0 |
| | | sprayer | | | | |
| 8 | Soap | aerosol | 1 | 19 | 21 | 4.5 |
| | Scum | sprayer | | | | |
| 13 | Grease | aerosol | 14 | 64 | >140 | 3.5 |
| | | sprayer | | | | |
| 2 | Mildew | osterizer | 2-6 | 11.5-21 | 26-66 | 15.5-20.5 |
| 17 | Mildew | osterizer | — | >11.5 | >55 | 16 |
| 20 | Mildew | osterizer | 14 | 5 | >47 | 37 |
| 21 | Mildew | osterizer | 14 | 7 | >28 | 21 |
| 22 | Mildew | osterizer | 11.5 | 29 | >40 | 17 |

Many different embodiments of the carrier foam described herein may be made without departing from the spirit and scope of the invention. Therefore, the scope of the invention is not intended to be limited except as indicated in the appended claims.

1. A carrier foam composition comprising a solution of one or more functional active agents and a surfactant, characterized by the composition being a fluid foam having, in combination,
a. a syneresis value in the range of 1 to 40%;
b. a foam horizontal thickness half-life of at least 8 minutes, and
c. a vertical-surface clingability of at least 4 minutes.

2. A carrier foam composition of claim 1 wherein the syneresis value is in the range of 2 to 40%, the foam horizontal thickness half-life is at least 12 minutes, and the vertical-surface clingability is at least 7 minutes.

3. A carrier foam composition of claim 1 wherein the syneresis value is in the range of 15-30%, the foam horizontal thickness half life is at least 15 minutes and the vertical surface clingability is at least 9 minutes.

4. A carrier foam composition of claim 1 wherein the surfactant is a cocamine oxide, a sodium alkyl alkanoate or sodium dodecyl diphenyl disulfonate or a mixture thereof that is present in the solution at a concentration in the range of 0.1 to 20%.

5. A carrier foam composition of claim 4 wherein the cleaning active agent is alkali metal hypochlorite and the precursor solution containing an override alkaline builder, the syneresis value is in the range of 1 to 60 %, the foam horizontal thickness half-life is in the range of 7 to 11 minutes, and the vertical-surface clingability is in the range of 4 to 7 minutes.

6. A carrier foam composition of claims 1, 2, 3 or 4 including at least one functional active agent selected from the group consisting of organic acids and inorganic acids.

7. A carrier foam composition of claim 6 wherein the at least one functional active agent is selected from the group consisting of acetic acid, oxalic acid, citric acid, sulfuric acid, hydrochloric acid, nitric acid, phosphoric acid and sulfamic acid.

8. A carrier foam composition of claims 1, 2, 3 or 4 including at least one functional active agent selected from the group consisting of organic bases.

9. A carrier foam composition of claim 8 wherein the at least one functional active agent is selected from the group consisting of ammonia, amines and salts thereof.

10. A carrier foam composition of claims 1, 2, 3 or 4 including at least one functional active agent selected from the group consisting of inorganic bases and carbonates.

11. A carrier foam composition of claim 10 wherein at least one functional active agent is selected from the group consisting of sodium hydroxide, potassium hydroxide, ammonium hydroxide, lithium hydroxide, sodium carbonate, potassium carbonate, calcium carbonate and lithium carbonate.

12. A carrier foam composition of claims 1, 2, 3 or 4 including at least one functional active agent selected from the group consisting of oxidizing and bleaching agents.

13. A carrier foam composition of claim 12 wherein at least one functional active agent is selected from the group consisting of sodium chlorite, hydrogen peroxide, sodium hypochlorite, potassium hypochlorite and lithium hypochlorite.

14. A carrier foam composition of claim 1, 2, 3 or 4 including at least one functional active agent selected from the group consisting of cleaners, lubricants, household pest control formulations, agricultural herbicide, pesticide and fungicide chemicals, industrial chemicals, institutional chemicals, medicinal chemicals, cosmetic chemicals and pharmaceutical chemicals.

15. A carrier foam composition of claim 14 wherein at least one functional active agent is selected from the group consisting of “Rust Stain remover” by Whink Products Co., “Lime Away” by Reckitt Benkeiser, “Windex” by S.C. Johnson, Inc. and “Pine-Sol” by Clorox, Inc.

16. A carrier foam composition of claim 1 4 wherein at least one functional active agent is selected from the group consisting of Hot-Shot Roach and ante Killer, distributed by Spectrum Group of United Industries, Inc. Round-Up Weed and Grass Killer, Ready-to-Use, distributed by Monsanto Company Lawn and Garden Products of Marysville, Ohio, Weed-B-Gone, distributed by Ortho Group of Columbus, Ohio, Bug-B-gone, distributed by Ortho Group of Columbus, Ohio, Triozicide, distributed by Spectrum Group of United Industry, Inc. of Saint Louis, Ohio, Ortho Garden Disease Control, distributed by Ortho Group of Columbus, Ohio, DW-40, distributed by DW-40 of San Diego, Calif., Liquid Wrench Super Penetrant, distributed by Radiator specialty company of Charlotte, N.C., Silicone Multi-Purpose Lubricant, distributed by CRC Industries, Inc. of Warminster, Pa. and Elmer's Slide-All with TEFLON Dry Spray lubricant, distributed by Borden, Inc., Dept. CP, Columbus Ohio.

17. A carrier foam composition of claims 1, 2, 3 or 4 including at least one functional active agent selected from the group consisting of quaternary ammonium compounds.

18. A carrier foam composition of claim 17 wherein at least one functional active agent is selected from the group consisting of alkyl dimethyl benzyl ammonium chloride, alkyl dimethyl ethyl benzyl ammonium chloride and alkyl dimethyl ammonium saccharinate.

19. A carrier foam composition of claims 1, 2, 3 or 4 wherein the one or more functional active agents includes a terpene.

20. A carrier foam composition of claims 1, 2, 3 or 4 including at least one functional active agent that is a mixture of a surfactant and a chelating agent.

21. A carrier foam composition of claim 20 wherein at least one functional active agent is ethylene diamine tetraacetic acid or its salts.

22. A carrier foam composition of claim 1 further including an enhancing agent selected from the group consisting of fragrances, coloring materials, surface shining agents, antibiotic agents, and coagulating agents.

23. A carrier foam composition of claim 22 wherein the fragrance is selected from the group consisting of “Fresh”, “RainFresh”, “Floral”, “Lemon”, “Orange”, or “Citrus”.

24. A carrier foam composition of claim 1 wherein the functional active agent is a topically applied liquid medication or a disinfectant.

25. A carrier foam composition of claim 1 wherein the functional active agent is selected from the group consisting of hydrogen peroxide, ethanol or isopropyl alcohol.

26. A carrier foam composition of claim 1 further including a secondary functional active agent selected from the group consisting of antibacterial agents, antistatic agents, antisoil and antistain agents, acarides, antislip agents, fungicides, enzymes and biologically active agents.

27. A carrier foam composition of claim 1 further including an override alkaline builder or a buffering agent.

28. A carrier foam composition of claim 27 wherein the override alkaline builder is selected from the group consisting of sodium hydroxide, potassium hydroxide, lithium hydroxide, calcium hydroxide, sodium carbonate, potassium carbonate, lithium carbonate, sodium bicarbonate, potassium bicarbonate and lithium bicarbonate.

29. A process for preparing a carrier foam composition fluid foam comprising the steps of (a) preparing an aqueous solution containing a cleaning active agent, and a surfactant compatible with the cleaning active agent at a surfactant concentration in the range of 0.1 to 20%, by weight and optionally a compatible fragrance, and (b) vigorously agitating the solution in the presence of a gas or propellant to form the foam.

30. A process of claim 29 wherein the vigorous agitation of the solution is performed with mechanical stirrers in the presence of air.

31. A process of claim 29 wherein the prepared solution is loaded into an aerosol dispenser having a valve assembly, a mechanical breakup actuator and a push button actuator containing a dispenser outlet, and a low-boiling propellant is injected under pressure into the dispenser and the vigorous agitation is performed by passing the mixture through the mechanical break-up actuator.

32. A process of claim 29 wherein the propellant is selected from the group consisting of propane, n-butane, isobutane and mixtures thereof, and the propellant is present in an amount in the range of 1 to 20% of the weight of the solution.

33. A process of claim 29 wherein the propellant is selected from the group consisting of 1,1-Difluoroethane, 1,1,1,2-Tetrafluoroetahne, mixtures thereof and Dimethyl ether in amount in the range of 1 to 20% of the weight of the solution.

34. A process of claims 32 or 33 whereby the propellant is used in amount in the range of 3 to 10% of the weight of the solution

35. A process of claim 31 wherein the aerosol dispenser has an extension tube with an inlet end and exit end, the inlet end of the extension tube being connected to the sprayer cap outlet or to the push button actuator outlet, and the mechanical break-up actuator being located in the exit end of the extension tube.

36. A process of claim 31 wherein the solution and the propellant are loaded into a pouch suspended within the dispenser, the pouch being separated from the container inner wall of the dispenser.

37. A process of claim 31 wherein the dispenser has a container and a cover, the container and cover being made of active-agent-compatible and pressure-resistant material of construction.

38. A process of claim 37 wherein the material of construction of the container and cover is selected from the groups of metals, glasses, high performance plastics and reinforced plastics.

39. A process of claim 38 wherein the container and cover are made of tin plate metal, carbon steel, stainless steel, tantalum metal, titanium metal, thick glass, glass-reinforced plastic, wire reinforced plastic or aramid fiber reinforced plastic.

40. A process of claim 31 wherein the dispenser has a container and a cover, the container and cover being made of metal, the container having an inner liner insert of an active agent-compatible polymer and the cover having laminated to its inner surface a layer of active agent-compatible polymer.

41. A foam drip collection device comprising a chamber with a front opening and a rear opening and a dam attached to the front opening, the rear opening of the chamber surrounding a foam spray nozzle of a sprayer cap mounted on the stem of an aerosol dispenser, wherein the front opening is sufficiently large and the front dam is sufficiently wide to hold, within its interior space, residual foam drips oozing out of the spray nozzle after use with the valve being shut off and also preventing foam jet emerging from the spray nozzle, during use, from touching the inner edges of the dam.

42. A process of claim 31 wherein the dispenser has a foam drip collection device of claim 36 attached to its valve assembly.

43. A process of claim 42 wherein the foam drip collection device is mounted on the valve assembly with a hinge and locks to provide for rotating the drip collection device to a resting position during storage.
